(19) United States
(12) Patent Application Publication
(10) Pub. No.: US 2004/0153800 A1
(43) Pub. Date: Aug. 5, 2004

(54) Device and system for maintaining a complex system, particularly an aircraft

(76) Inventor: Serge Germanetti, Marseille (FR)

Correspondence Address: STEVENS, DAVIS, MILLER & MOSHER, LLP, Suite 850, 1615 L Street, NW, Washington, DC, 20036, US

(21) Appl. No.: 10/463,856

(22) Filed: Jun. 18, 2003

(30) Foreign Application Priority Data
Jun. 19, 2002 (FR) 02 07552

(51) Int. Cl. H04L 1/22

(52) U.S. Cl. 714/30

(57) ABSTRACT

The maintenance device (2) comprises electronic equipments (4A, 4B, 4C) each comprising a test means (5A, 5B, 5C) and a memory (6A, 6B, 6C) for recording information relating to a fault, a central unit (8) comprising a test means (10), a memory (11), a computer (12) which receives information from, the electronic equipments (4A, 4B, 4C) indicating the test means that detected a fault, which determines, from this information, a faulty element and which indicates, on a screen (16, 17) while the complex system is in operation, the occurrence of a fault and the faulty element and, at the end of operation, a list of the faults that have occurred, with the faulty elements, a memory (13) for recording the information processed by the computer (12), and interfaces for accessing said memories.

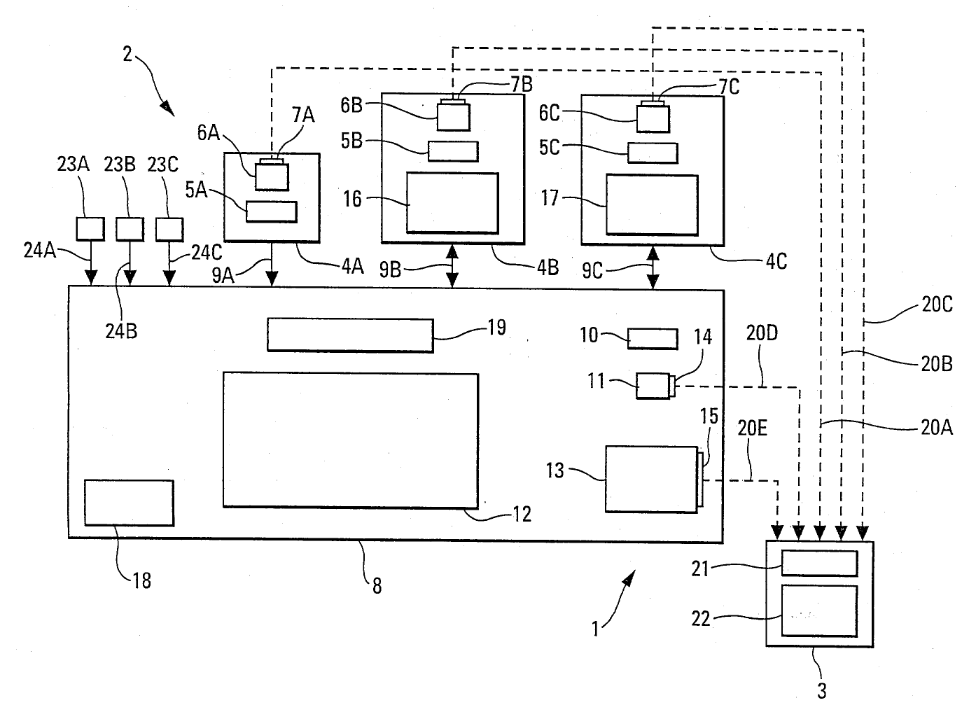

The present invention relates to a device and a system for maintaining a complex system, particularly an aircraft.

In the context of the present invention, a complex system is to be understood as meaning a system comprising a plurality of elements (components), particularly electronic, mechanical and hydraulic ones, with numerous interconnections. Complex systems of this type exist in very varied spheres of activity, such as in industry, in the motor trade and in aviation for example.

Such a complex system, particular in an aircraft such as a helicopter, is often difficult to maintain because of the difficulties encountered, when a fault or failure occurs in said complex system, of locating the element or elements responsible for this failure and which are therefore actually faulty. These difficulties are essentially due to the very high number of components and interconnections that there are in said complex system, which it is impossible to monitor individually.

The present invention relates to a maintenance device the purpose of which is to overcome these disadvantages.

To this end, said device is notable according to the invention in that it comprises at least:

a plurality of electronic equipments which are mounted on said complex system, each of said electronic equipments comprising:

at least one built-in test means for detecting a fault while the complex system is in operation;

at least one first test memory for recording, when a fault is detected by said test means, information relating to this fault; and

an interface providing access to said first test memory; and

a central unit mounted on said complex system, connected to said electronic equipments and which comprises:

at least one built-in test means for detecting a fault while the complex system is in operation;

at least one second test memory for recording, when a fault is detected by said test means, information relating to this fault;

a computer which receives, when a fault is detected, information from said electronic equipments indicating the test means that detected the fault, which attempts to determine, from this information, at least one faulty element in said complex system and which is able to indicate on a display screen:

while the complex system is operating, automatically, the occurrence of a fault and, if it has been determined, the corresponding faulty element; and

at the end of operation of the complex system, on request, a list of the faults that occurred during operation, with the corresponding faulty elements;

at least one maintenance memory for recording all the information processed by said computer; and

at least one interface providing access to said second test memory and to said maintenance memory.

Thus, by virtue of the invention:

when the complex system is in operation, that is to say during the flight in the case of an aircraft, an operator (pilot, etc) is automatically informed of the occurrence of any fault and of the defective elements that have been identified; and

at the end of operation of the complex system, that is to say, in the case of an aircraft, when it comes to a standstill on the ground, the operator can access the list of faults that have occurred during operation, with, in addition, the identity of the faulty elements.

For this, as said computer of the central unit collects information supplied by all said electronic equipments, it can very reliably determine which element or elements is or are responsible for a fault. In addition, since the test means are directly built into the various electronic equipments, they can carry out highly targeted tests and therefore analyze individual components of these equipments, this making it possible to refine the search for the faulty elements.

In addition and above all, by virtue of the information recorded in said first and second test memories and in said maintenance memory, and to which access can be had via said interfaces, it is possible to write a very detailed maintenance report, as will be seen in greater detail hereinbelow.

To this same end, advantageously, the maintenance device additionally comprises a plurality of sensors able to measure the values of parameters of the complex system, while it is operating, and to transmit the measured values to said central unit so that they can be recorded in said maintenance memory.

Furthermore, said central unit additionally comprises filtering means, in particular making it possible to determine whether a fault is intermittent or permanent.

Furthermore:

in a simplified first embodiment, said display screen forms part of the central unit; and

in a preferred second embodiment, said display screen forms part of a display system which represents an electronic equipment of the aforementioned type, that is to say one equipped with at least one built-in test means, with a first test memory and with an interface. In this case, said maintenance device preferably comprises two display systems of this type, for example EID (Electronic Instrument Display) systems.

Furthermore, for reliability reasons, said central unit is advantageously produced with dual architecture.

Furthermore, in one particular embodiment, said computer displays, on request, at the end of operation of the complex system, on said display screen, at least a diagnostic table which represents a compilation comprising, for each fault, at least the following information:

the test or tests performed;

the element or elements likely to be responsible for the fault;

the probability of these elements being faulty, or any other indicator associated with this probability.

The present invention also relates to a maintenance system which comprises, in addition to a maintenance device like the aforementioned one, a portable maintenance unit, preferably a portable computer, able to be connected, via at least one digital link to said interfaces of said first test memories, of said second test memory and of said maintenance memory and which comprises:

a processing means able to receive and to process the information recorded in said first and second test memories and said maintenance memory and to form, from this information, a (detailed) maintenance report; and

information-presenting means able to present said maintenance report to an operator.

Thus, since said maintenance unit has direct access to all the (fault-related) information available in the various memories (test memories, maintenance memory), it knows the context (events, values in particular parameters, etc) surrounding each of the faults, which means that said processing means can then:

on the one hand, refine the results of the processing operations performed by the central unit computer; and

on the other hand, write a particularly detailed and reliable maintenance report.

In a preferred embodiment, said maintenance unit forms and presents the maintenance report, at least in part, on at least a diagnostic table which represents a compilation comprising, for each fault, at least the following information:

the test or tests performed;

the element or elements likely to be responsible for the fault;

the probability of these elements being faulty, or any other indicator associated with this probability.

It is also possible to provide at least one means allowing the diagnostic table or tables to be amended, for example adding or removing tests or amending the analysis of the faulty elements.

The single FIGURE of the attached drawing will make it easy to understand how the invention may be achieved. This FIGURE depicts a block diagram of the maintenance system according to the invention.

The maintenance system 1 according to the invention and depicted in the FIGURE is intended to assist a maintenance operator in maintaining a complex system, that exists in particular in industry, in the motor trade or in aviation. More particularly, said maintenance system 1 will be described hereinbelow, by way of example, as a system to assist with the maintenance of an aircraft, such as a helicopter for example.

According to the invention, said maintenance system 1 comprises:

a maintenance device 2 mounted on board the aircraft; and

a maintenance unit 3, of portable type, particularly a portable personal computer, which can be connected to said maintenance device 2 when the aircraft is stationary on the ground, as specified hereinbelow.

According to the invention, said maintenance device 2 comprises:

a plurality of electronic equipments 4A, 4B, 4C mounted on board said aircraft. By way of example, mention may be made of computers, display systems, an automatic pilot and systems for monitoring apparatus or parts (engines, etc) of the aircraft. Each of said electronic equipments 4A, 4B, 4C comprises:

at least one built-in test means 5A, 5B, 5C for detecting a fault while the aircraft is in operation (flight);

at least one test memory 6A, 6B, 6C for recording, when a fault is detected by said test means 5A, 5B, 5C, information relating to this fault; and

an interface 7A, 7B, 7C giving access to said first test memory 6A, 6B, 6C; and

a central unit 8 mounted on board said aircraft, connected to said electronic equipments 4A, 4B, 4C by links 9A, 9B, 9C respectively, and which comprises:

at least one built-in test means 10 for detecting a fault while the complex system is in operation;

at least a first test memory 11 for recording, when a fault is detected by said test means 10, information relating to this fault;

a computer 12 which receives, when a fault is detected, information from said electronic equipments indicating in particular the test means 4A, 4B, 4C (or 11) that detected the fault and which attempts, on the basis of this information, to determine at least one faulty element of said aircraft;

at least one maintenance memory 13 for recording all the information processed by said computer 12; and

interfaces 14 and 15 giving access to said test memory 11 and to said maintenance memory 13.

In addition, said computer 12 is able to indicate on a display screen 16, 17:

while the complex system is operating, that is to say while the aircraft is in flight, in operational mode, automatically, the occurrence of a fault and, if determined, the corresponding faulty element; and

at the end of operation of the complex system, that is to say when the aircraft returns to the ground, in maintenance mode, on request, a list of the faults that occurred during operation with the corresponding faulty elements. For this, the central unit 8 comprises a means 18, for example an alphanumeric keypad, allowing an operator to communicate with said computer 12 and in particular to make such a request.

The central unit 8 additionally comprises filtering means 19 making it possible in particular to determine whether a fault is intermittent or permanent, to count the number of occurrences of intermittent faults and to identify the moment in time at which these faults occurred.

More specifically, in operational mode, the computer 12 identifies, when there is a fault, a failed element when this has been located with a reliability considered to be relatively high.

In this case, the central unit 8 sends out a message (for example “see status page”) on a particular page (for example the “engine page”) of the display screen 16, 17, in order to inform an operator as to where the information relating to the fault can be found. The identity of the failed element is thus displayed on this status page. It is possible to envision for the aforementioned message to be eliminated once an operator (pilot, etc) has opened this status page for a first time.

Furthermore, when no failed element has :been determined, following a fault, the status page may contain an appropriate message, (for example “non-localized failure”).

In a simplified first embodiment that has not been depicted, said display screen forms part of said central unit 8.

In a preferred second embodiment that has been depicted, said display screen 16, 17 forms part of a display system 4B, 4C which represents an electronic equipment equipped at least with a built-in test means 5B, 5C, with a test memory 6B, 6C and with an interface 7B, 7C. In this case, said maintenance device 2 comprises, as a preference, two display systems 4B and 4C of this type, for example EID (Electronic Instrument Display) systems as depicted in the figure.

One of these display systems 4B and 4C may be intended in addition for displaying parameters pertaining to the aircraft engines and the other for displaying parameters of the aircraft, such as the temperature or pressure in the gearboxes for example.

Furthermore in addition to managing the maintenance as stated above, the central unit 8 may also manage the power and limitations of the engines, the condition of the drive lines and of the hydraulic system, and various messages relating to equipments of the aircraft.

Furthermore, in an alternative form that has not been depicted, the central unit 8 may be produced, for reliability and safety reasons, with dual architecture. For this, at least the computer 12 and the filtering means 19 may be duplicated so as to obtain two separate data acquisition, filtration and processing channels. In a preferred embodiment, each of these two channels is associated with and connected to one of said display systems 4B and 4C.

Furthermore, according to the invention, said portable maintenance unit 3 is able to be connected, via conventional digital links 20A, 20B, 20C, 20D, 20E respectively to said interfaces 7A, 7B, 7C, 14, 15 of said test memories 4A, 4B, 4C, 11 and of said maintenance memory 13, and comprises:

a processing means 21 capable of receiving and of processing the information recorded in said test memories 4A, 4B, 4C, 11 and in said maintenance memory 13, and of forming, from this information, a detailed maintenance report specified hereinbelow; and

information presentation means 22, for example a display screen, capable of presenting said detailed maintenance report to an operator.

Thus, as said maintenance unit 3 has direct (and separate) access to all the (fault-related) information available in the various memories 6A, 6B, 6C, 11, 13, it knows the context (events, values of particular parameters, etc) surrounding each of the failures so that said processing means 21 can then:

on the one hand, if necessary refine the results of the processing operations performed by the computer 12 of the central unit 8; and

on the other hand, write a particularly detailed and reliable maintenance report.

More specifically, the maintenance unit 3 thus knows, for example:

the fault detection modes used;

the nature and history of each fault (permanent/intermittent);

the precise times at which the faults occurred; and

possibly test procedures required in order to set aside any ambiguity in fault findings or to confirm the existence of a fault.

Furthermore, to allow the maintenance unit 3 to access additional information, the maintenance device 2 additionally comprises a plurality of conventional sensors 23A, 23B, 23C connected respectively by links 24A, 24B, 24C to the central unit 8 and able to measure the values of various parameters (speed, pressure, altitude, etc) of the aircraft while it is operating, and to transmit the measured values to said central unit 8, so that they can be recorded in said maintenance memory 13 and communicated to the portable maintenance unit 3.

The maintenance unit 3 according to the invention makes it possible:

to achieve a fault coverage rate of close to 100%;

to have just one maintenance tool;

to analyze and exploit the maintenance data;

to obtain a history of faults for each equipment;

to provide assistance with maintenance in conjunction with technical documents; and possibly

to create a maintenance database.

In addition, in one particular embodiment, said maintenance unit 3 is formed to exploit the data, classifying them using the following filtration criteria:

maintenance session number;

time at which the fault occurred;

time at which the fault disappeared (if the fault is absent or intermittent);

number of occurrences, if the fault is intermittent;

a display of the first three and of the last occurrence, if the fault is intermittent;

the incorporation of the fault detection mode;

the incorporation of the test number and of associated additional data; and

the probability of location in the case of a fault ambiguity.

In a preferred embodiment, said maintenance unit 3 forms and presents (for example on the screen 22) at least a part of the maintenance report, in at least one diagnostic table which represents a compilation comprising, for each fault, at least the following information (which is thus classified by appropriate filters forming said diagnostic table):

the test or tests performed;

the element or elements likely to be responsible for the fault;

the probability of these elements being faulty, or any other indicator associated with this probability (colour code, relative percentage, etc).

In the context of the present invention, it is possible to envision the computer 12 also performing such a classification on the basis of a diagnostic table of the same type.

The diagnostic tables are loaded into the processing means 21 (and/or into the computer 12) and can be replaced or updated quickly and easily using conventional computer means, not depicted. Such updating therefore requires no structural modification to the maintenance system 1 according to the invention.

Furthermore, in the context of the present invention, other electronic equipments may be added to said maintenance system 1 quickly and easily.

1. Device for maintaining a complex system, particularly an aircraft,
which comprises at least:
a plurality of electronic equipments (4A, 4B, 4C) which are mounted on said complex system, each of said electronic equipments (4A, 4B, 4C) comprising:
at least one built-in test means (5A, 5B, 5C) for detecting a fault while the complex system is in operation;
at least one first test memory (6A, 6B, 6C) for recording, when a fault is detected by said test means (5A, 5B, 5C), information relating to this fault; and
an interface (7A, 7B, 7C) providing access to said first test memory (6A, 6B, 6C); and
a central unit (8) mounted on said complex system, connected to said electronic equipments (4A, 4B, 4C) and which comprises:
at least one built-in test means (10) for detecting a fault while the complex system is in operation;
at least one second test memory (11) for recording, when a fault is detected by said test means (10), information relating to this fault;
a computer (12) which receives, when a fault is detected, information from said electronic equipments (4A, 4B, 4C) indicating the test means that detected the fault, which attempts to determine, from this information, at least one faulty element in said complex system and which is able to indicate on a display screen (16, 17):
while the complex system is operating, automatically, the occurrence of a fault and, if it has been determined, the corresponding faulty element; and
at the end of operation of the complex system, on request, a list of the faults that occurred during operation, with the corresponding faulty elements;
at least one maintenance memory (13) for recording all the information processed by said computer (12); and
at least one interface (14, 15) providing access to said second test memory (11) and to said maintenance memory (13).

2. Device according to claim 1, which additionally comprises a plurality of sensors (23A, 23B, 23C) able to measure the values of parameters of the complex system, while it is operating, and to transmit the measured values to said central unit (8) so that they can be recorded in said maintenance memory (13).

3. Device according to claim 1, wherein said central unit (8) additionally comprises filtering means (19).

4. Device according to claim 1, wherein said display screen (16, 17) forms part of a display system (4B, 4C) which represents an electronic equipment additionally equipped with a built-in test means (5B, 5C), with a first test memory (6B, 6C) and with an interface (7B, 7C).

5. Device according to claim 4, which comprises two display systems (4B, 4C).

6. Device according to claim 1, wherein said display screen forms part of said central unit.

7. Device according to claim 1, wherein said computer (12) displays, on request, at the end of operation of the complex system, on said display screen (16, 17), at least a diagnostic table which represents a compilation comprising, for each fault, at least the following information:
the test or tests performed;
the element or elements likely to be responsible for the fault;
the probability of these elements being faulty, or any other indicator associated with this probability.

8. Device according to claim 7, which additionally comprises a means allowing the diagnostic table to be amended.

9. Device according to claim 1, wherein said central unit (8) is produced with dual architecture.

10. System for maintaining a complex system, particularly an aircraft, which comprises:
said maintenance device (2) specified in claim 1; and
a portable maintenance unit (3) able to be connected, via at least one digital link (20A, 20B, 20C, 20D, 20E) to said interfaces of said first test memories (4A, 4B, 4C), of said second test memory (11) and of said maintenance memory (13) and which comprises:
a processing means (21) able to receive and to process the information recorded in said first and second test memories (4A, 4B, 4C, 11) and said maintenance memory (13) and to form, from this information, a maintenance report; and
information-presenting means (22) able to present said maintenance report to an operator.

11. System according to claim 10, wherein said maintenance unit (3) forms and presents the maintenance report, at least in part, on at least a diagnostic table which represents a compilation comprising, for each fault, at least the following information:
the test or tests performed;
the element or elements likely to be responsible for the fault;
the probability of these elements being faulty, or any other indicator associated with this probability.

12. System according to claim 11, which additionally comprises a means allowing the diagnostic table to be amended.

13. System according to claim 10, wherein said maintenance unit (3) is a portable personal computer.
